(19) United States
(12) Patent Application Publication
(10) Pub. No.: US 2005/0113486 A1
(43) Pub. Date: May 26, 2005

(54) Molded articles having a granular or speckled appearance and process therefor

(76) Inventors: Kevin Robert Sandieson, Lake Milton, OH (US); Thomas S. Fanara, Stow, OH (US)

Correspondence Address: Thomas W. Adams;Renner, Otto, Boisselle & Sklar, LLP, Nineteenth Floor, 1621 Euclid Avenue, Cleveland, OH, 44115-2191, US

(21) Appl. No.: 10/722,612

(22) Filed: Nov. 26, 2003

(51) Int. Cl. B29C 41/22; C09D 5/29

(52) U.S. Cl. 523/171; 264/140; 264/74; 264/141; 264/310

(57) ABSTRACT

A process for making a molded article having a granular or speckled appearance, including color compounding a first polymeric material and at least one pigment to form a color compound of the at least one pigment with the first polymeric material; comminuting the color compound; mixing the reduced particle size color compound with a second polymeric material having a color different from or contrasting with the at least one pigment to form a mixture wherein the reduced particle size color compound is distributed in the second polymeric material; and molding the mixture to form a molded article having a granular or speckled appearance, and an article.

### TECHNICAL FIELD

The present invention relates to processes for making molded articles having a granular or speckled appearance.

### BACKGROUND OF THE INVENTION

Rotational molding (also known as rotomolding or rotary molding) is used to manufacture hollow objects from thermoplastics. For the last three decades, rotational molding of plastics has received much attention because of the low machinery cost, simple tooling, and low level of waste involved. In the basic process of rotational molding, dry-blended, comminuted polymer is placed in a mold. The mold is closed and rotation of the mold on at least one axis is started. The mold can be rotated uniaxially or biaxially and is usually rotated biaxially, i.e., rotated about two perpendicular axes simultaneously. The mold is typically heated externally and is later cooled while still being rotated. As the softening point or melting point of the polymer is reached during the heating, the polymer begins to fuse or sinter into the shape of the mold cavity. After all of the polymer has fused, the mold is cooled. As such, rotational molding is a zero shear process and involves the tumbling, heating and melting of thermoplastic powder, resulting in coalescence, fusion or sintering of the powder, followed by cooling. In this manner, articles may be obtained having complex shapes, being large in size and being substantially uniform in wall thickness. A detailed discussion of the rotational molding process and specific polymeric materials, is referred to in the article appearing in Modern Plastics Encyclopedia (1995) at page D171, the disclosure of which relating to rotational molding is hereby incorporated by reference.

Thermoplastic molding compositions having various properties, including a sand-, stone- or granite-like granular or speckled appearance, in which the articles have, for example, contrasting color properties, are in demand in a variety of industries and for a variety of applications, ranging from toys to decorative household and outdoor articles. A number of methods are known in the art for imparting such a granular or speckled appearance to such articles. Many of the methods require the use of additives such as solvents, dispersants, modifiers, extenders, and/or require the addition of other non-thermoplastic materials such as fibers or metal flakes and other known additives, and/or require the use high levels of fillers to provide a distinct granular or speckled appearance. Such additives, materials and fillers may increase the cost and/or decrease the environmental acceptability of such compositions. Other methods involve use of additives such as thermoplastic materials having different chemical make-up and/or different physical properties from the base or primary material of which the composition is formed. In these latter methods, the thermoplastic materials added are intended to remain distinct from the base or primary polymeric material and to thus provide a distinct granular or speckled appearance to the overall product. In addition to increasing the costs of the article and processing, use of the foregoing additives, materials and fillers may also result in changes in the physical properties of such articles, as compared to the original thermoplastic material. For example, the impact resistance may be significantly reduced due to the presence of the different materials.

In addition to the foregoing methods, other methods involve the use of recycled and re-ground pigmented thermoplastics, which are sometimes used as a source of particles having a contrasting color in producing articles having such granular or speckled appearance. However, such recycled and re-ground thermoplastics are usually mixtures of a variety of different thermoplastics, and may also include non-thermoplastic materials, such as thermoset materials, rubbers, textile materials, glass fibers, fillers and other such materials. Such recycled and re-ground thermoplastics containing these type materials, when blended with a thermoplastic material, may obtain a speckled appearance, but as a result of the non-homogenous materials the physical properties of the thermoplastic material are modified, including changes in important physical properties of such articles, as compared to the original thermoplastic material. Such physical properties include, for example, arm impact strength, tensile strength, and dart impact strength.

According to conventional rotational molding procedures, the polymers for rotational molding are prepared by combining powdered polymer product with powdered colorant. The colorant is made by, e.g., combining a pigment with a polymer. In most cases the polymer used to produce the colorant is the same as or similar to the polymer product with which it will be combined. The combined polymer product and colorant are thoroughly mixed and subsequently fed to the rotational molding equipment.

In the past, when it has been desired to create a product with a granular or speckled appearance, various heterogenous materials were added to the combined polymer product and colorant during mixing prior to molding or, in some cases, by melt compounding the heterogenous material with the polymer product prior to grinding the polymer product to powder. The heterogenous materials may include such materials as those mentioned above. These methods either cannot obtain a granular appearance or, when it is attempted to do so, these methods result in an article which has poorly-defined variegated colors and/or which has physical properties much inferior to those of the base polymer molded without such additives. The molded article made by such method may have a mottled appearance, in which there is no clear separation between the contrasting colors or in which the colors are blended together at least in the areas of the boundaries, so that there is very little granular or speckled appearance in the molded article. In some such conventional mixtures, the particles of a contrasting color may have a “halo” or “aura” surrounding each particle, in which the polymer and color of the particle have partially blended into the polymer and color of the surrounding background material.

It is desirable for articles to have a granular or speckled appearance to have a sand-like or granite-like appearance, in which the contrasting color particles are randomly but substantially uniformly distributed in a background having a different color or shading. The contrasting color particles should be distinct particles having relatively sharp, distinct boundaries. That is, the contrasting color particles should not be partially melted or diffused into the surrounding background material, but should remain separate from the background material in which the contrasting color particles are dispersed. However, in the prior art, achieving such appearance has been difficult and has involved undesirable trade-offs. In the prior art, in some cases in order to achieve such distinctness, the contrasting color particles have been made from a substantially different material from the material of which the surrounding background is made, or a number of different additives have been required in order to obtain the desired appearance. While this may achieve the desired granular or speckled sand-like appearance, mixing different materials sacrifices the physical properties of the resulting article as a result of the mixing of substantially different materials which necessarily have dissimilar properties. Loss of physical properties means that the useful lifetime of the article may be significantly reduced, and may also mean that the appearance and function of the article are also compromised.

While it is possible to overcome some of the foregoing problems known in the art, such as by the use of special processing steps or the addition of more additives for adjusting the properties, such methods used to overcome these problems further increase the cost of the articles and of the processes of producing the articles and, even then the product may not display a granular appearance with a substantially randomly uniform distribution of distinct particles in the background material of the molded article, and may nevertheless sacrifice physical properties of the article.

Accordingly, a continuing need exists for improved processes for producing articles having a distinct, granular or speckled appearance at lost cost and with good physical properties corresponding to properties obtained from a substantially uniform, single polymer or resin.

### SUMMARY OF THE INVENTION

In one embodiment, the present invention relates to a process for making a molded article having a granular appearance, including color compounding a first polymeric material and at least one pigment to form a color compound of the at least one pigment with the first polymeric material; comminuting the color compound to form a reduced particle size color compound; mixing the reduced particle size color compound with a second polymeric material having a color different from or contrasting with the at least one pigment to form a mixture wherein the reduced particle size color compound is distributed in the second polymeric material; and molding the mixture to form a molded article having a granular appearance.

In one embodiment, the present invention relates to a molded article having a speckled appearance with contrasting color properties, including particles of a color compound of a first polymeric material and at least one pigment; and a second polymeric material having a color different from or contrasting with the pigment, wherein in the molded article the second polymeric material forms a substantially uniform background and the particles of the color compound are substantially randomly and uniformly distributed throughout the second polymeric material and are substantially distinct from the second polymeric material.

In one embodiment, at least one physical property of the article in accordance with the invention is substantially the same as the at least one physical property of an article made with only the second polymeric material.

Thus, in accordance with the present invention, an article having a granular or speckled appearance can be produced without sacrificing important physical properties.

### BRIEF DESCRIPTION OF THE DRAWINGS

FIG. 1 is a schematic flow diagram illustrating a process in accordance with the present invention.

FIGS. 2 and 3 are photographs of articles made in accordance with the process of the present invention.

### DETAILED DESCRIPTION

It should be appreciated that the process steps and structures described below do not form a complete process flow for manufacturing and using an end-product made by a process including the present invention. The present invention can be practiced in conjunction with fabrication techniques currently used in the art, and only so much of the commonly practiced process steps are included as are necessary for an understanding of the present invention.

The present invention relates to a process for making a molded article having a granular or speckled appearance. In the present invention, the process for making a molded article having a granular or speckled appearance includes steps of color compounding a first polymeric material and at least one pigment to form a color compound of the at least one pigment within the first polymeric material, comminuting the color compound to form a reduced particle size color compound, mixing the reduced particle size color compound with a second polymeric material having a color different from or contrasting with the at least one pigment to form a mixture wherein the reduced particle size color compound is distributed in the second polymeric material, and molding the mixture to form a molded article having a granular appearance. By this method, the molded article has a granular or speckled appearance in which the background color, obtained from the second polymeric material, is distinctly and sharply separated from the differently-colored particles of the color compound. In one embodiment, the first and second polymeric materials are substantially the same. In one embodiment, the molded article retains substantially all the physical properties of a single polymeric material when the first and second polymeric materials are substantially the same. In one embodiment, the first and second polymeric materials are both rotationally moldable polymeric materials. In one embodiment, the molding is rotational molding.

An important aspect of the present invention is that while the particles of the color compound and the second polymer remain separate and distinct to a degree sufficient to provide the desired granular or speckled appearance in the molded article, the respective particles are of such similar composition that the molded article has the physical properties of an article made from a single polymeric material, e.g., substantially the physical properties of the second polymeric material. Because the particles of the color compound are so similar in composition to the particles of the second polymeric material which makes up the background of the molded article, physical properties of the molded article can be predicably controlled. This is an advantage not found in the prior art, in which dissimilar materials (such as non-polymeric materials, chemically different polymeric materials, or similar polymeric materials having substantially different properties such as molecular weight, density, Vicat softening point or melt flow index) are added to obtain the granular or speckled appearance.

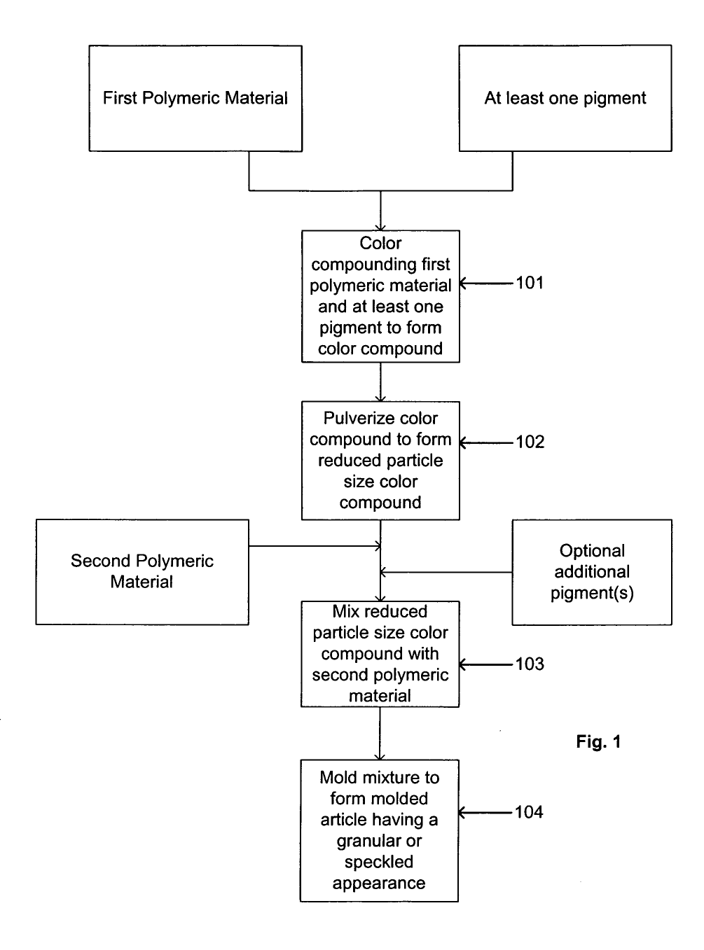

FIG. 1 is a schematic flow diagram illustrating a process in accordance with the present invention. As shown in FIG. 1, a first polymeric material and at least one pigment are provided. In one embodiment, the at least one pigment, or a single pigment, is provided in the form of a colorant, in which the pigment has been mixed with, dispersed in, or otherwise combined with a carrier, such as a polymeric material, to form the colorant. In the process for a molded article having a granular appearance, several steps are carried out, as shown in FIG. 1. In the first step of the process, shown schematically as step 101, the first polymeric material and the at least one pigment are color compounded to form a color compound of the at least one pigment with the first polymeric material. The color compounding may be carried out by any appropriate method, and in one embodiment, the color compounding is carried out by extruding the first polymeric material and the pigment-containing colorant. The output from the extruder is chopped or cut or otherwise formed into pellets of the color compound. A number of color compounds may be prepared for use together in a single molded article.

In the next step of the process shown in FIG. 1, shown schematically as step 102, the color compound is comminuted to reduce its particle size. The step of comminuting may be carried out in any appropriate device. The particle size may be selected as appropriate, and in one embodiment, the particle size is in the range from about 30 to about 40 U.S. mesh. For example, in the rotary molding art, a particles of 35 mesh are often used.

A second polymeric material is provided. The second polymeric material, as discussed herein, in one embodiment may be the same as, or substantially similar to, the first polymeric material. As discussed herein, the second polymeric material may be substantially the same as or identical to the first polymeric material in one or more of density, melt flow index or Vicat softening point. In general, the second polymeric material has a color different from or contrasting with one or more of the at least one pigments used in forming the color compound. In one embodiment, the second polymeric material has such different color as a result of adding a pigment or colorant thereto, while in another embodiment, the different color is simply the natural color of the second polymeric material. In one embodiment, the second polymeric material has an average particle size substantially the same as, or in a range overlapping, the average particle size of the reduced particle size color compound. In one embodiment, when providing the second polymeric material, one or more additional pigments and/or colorants may be provided, together with or in addition to, the second polymeric material. These additional pigments and/or colorants may be used, for example, as the background color for the molded article, against which the color or colors of the color compound contrast.

In the next step of the process shown in FIG. 1, shown schematically as step 103, the reduced particle size color compound is mixed with the second polymeric material having a color different from or contrasting with the at least one pigment to form a mixture wherein the reduced particle size color compound is distributed in the second polymeric material. The step of mixing is carried out until the mixture of the reduced particle size color compound and the second polymeric material is substantially homogenous and the differently colored particles are substantially uniformly and randomly distributed therein.

In the final step of the process shown in FIG. 1, shown schematically as step 104, the mixture is passed into a molding apparatus and is molded to form a molded article having a granular or speckled appearance. In one embodiment, the molding apparatus is a rotary molding apparatus.

In the following, additional details are provided relating to each of the major steps in the process according to the present invention.

Color Compounding

The step of color compounding may be carried out by any appropriate known process for mixing the at least one pigment or colorant with the first polymeric material. In this step, the at least one pigment or colorant is thoroughly, intimately mixed with the first polymeric material. Generally in this step the pigment or colorant and the polymeric material are melted together and then formed into particles such as pellets. In one embodiment, a colorant is mixed with the first polymeric material. In another embodiment, a pigment is mixed with the polymeric material. In yet another embodiment, reground, colored polymeric material is used directly as the first polymeric material, and in another embodiment, reground, colored polymeric material is used as the combined first polymeric material and the at least one pigment or colorant, and is color compounded, as described in more detail below.

In the color compounding step, the pigment or colorant is intimately mixed with the first polymeric material, for example, by melting together, mixing thoroughly, and then extruding the color compound. In one embodiment, the pigment(s) may be considered to be encapsulated by the first polymeric material, or may be considered to be in, as opposed to being physically on surfaces of, the first polymeric material. In one embodiment, the color compounding is carried out by an extrusion process using, for example, a single- or double-screw extruder. In one embodiment, the color compounding is carried out by melt mixing followed by a pelletizing step, which may be extrusion or other appropriate method of pelletizing the color compound produced by the color compounding step. In one embodiment, the color compounding step, color compounding the first polymeric material with the pigment(s), is carried out at a temperature above the melting points of both the first polymeric material and of the pigment(s). In general, the melting point of organic pigments is well below the melting point of the polymeric material. In one embodiment, the color compounding step is carried out at a temperature above the melting point of the first polymeric material.

In one embodiment, the color compounding comprises extrusion of the first polymeric material and the at least one pigment. In one embodiment, the color compound has a substantially uniform distribution of the at least one pigment within the first polymeric material. In one embodiment, the step of color compounding is carried out in any suitable single or double screw extruder, e.g. an extruder having a barrel of about 1 to about 4 inch diameter, or smaller or larger, depending on the quantity of extrudate. Suitable extruders can be selected by those of ordinary skill in the art.

In one embodiment, reground polymeric material which already has a pigment or colorant is used as the material which is color compounded. Thus, in this embodiment, the reground polymeric material is melted together, mixed thoroughly, and then extruded to yield the color compound. In one such embodiment, a polymeric material which has suitable properties as disclosed above for the first polymeric material, but which has already been made into a product including one or more suitable colorant or pigment, is obtained, is color compounded as described above (except that it may not be necessary to add additional pigment or colorant), then is reground to a particle size substantially the same as that described above for the comminuting step, and is then used in the steps described herein after as the reduced particle size color compound. In one embodiment, additional pigment or colorant is added to the reground polymeric material prior to the color compounding step. For example, if the reground polymeric material includes more than one color of polymeric material, a black colorant may be added, and the material produced used to prepare a product containing black granules or speckles.

In one such embodiment, the loading of colorants or pigments in the reground polymeric material is substantially similar to the loading of colorants or pigments which would be included in the color compound, as described above. In such an embodiment, it may not be necessary to add additional colorant or pigment, although this may be done as needed. In one such embodiment, the polymeric material in the reground material is the same polymeric material which would be used as the first polymeric material. In another such embodiment, the polymeric material in the reground material is the same polymeric material which would be used as the second polymeric material. In another such embodiment, the polymeric material in the reground material is the same polymeric material which would be used as both the first and the second polymeric material. In any case, the reground material should be subjected to one of the color compounding treatments described above in order to obtain the desired granular or speckled appearance. It is noted that, if reground polymeric material is used directly as the comminuted color compound without the step of color compounding, and is blended with the second polymeric material as described below, the product obtained generally does not have the granular or speckled appearance obtained by the present invention.

Comminuting

In one embodiment, comminuting the color compound includes reducing the particle size of the color compound by one or more of cutting, chopping, grinding or milling, as known in the art, thereby forming a reduced particle size color compound. In one embodiment the particle size may be selected by varying the screen size through which comminuted particles escape or are removed from the apparatus used for reducing the particle size. The step of comminuting the color compound to reduce its particle size may be carried out in any suitable apparatus. In one embodiment, the step of comminuting the color compound is carried out in a Wedco Grinder, available from Wedco Inc., Bloomsbury, N.J. Suitable grinders are also available from Orenda, Reduction Engineering, Pallmann, and others.

By selecting and controlling the particle size in the comminuting step, the appearance of the molded article can be controlled. In one embodiment, the particle size of the second polymeric material may be reduced to substantially the same size as that of the reduced particle size color compound. In another embodiment, the particle size of the reduced particle size color compound is larger than that of the second polymeric material, resulting in a molded article having larger granules or speckles of the contrasting color particles. By selecting and controlling the particle size of the color compound and the second polymer, the overall appearance of the molded article can be selected and controlled.

In the comminuting step, the color compound is comminuted to a smaller particle size. In one embodiment, in the comminuting step, the color compound is comminuted to a particle size (or to a mesh size) which is substantially the same as that of the second polymeric material, with which the comminuted color compound will be combined in the process of making the molded article.

The particle size may be suitably controlled by use of a classifier or other appropriate particle size separator.

In one embodiment, the granular appearance includes a controllable granule size in the molded article. In one embodiment, the controllable granule size is controlled in the step of comminuting to reduce the particle size of the color compound. By selecting the particle size, the size of the granules or speckles in the molded article can be selected to present the desired effect, e.g., to appear like sand, or granite or some other material having a granular or speckled appearance.

In one embodiment, the average particle size of the comminuted color compound ranges from about 30 mesh to about 50 mesh, and in one embodiment from about 33 to about 37 mesh, and in one embodiment, about 35 mesh. The average particle size of the comminuted color compound thus ranges from about 600 microns to about 290 microns, or from about 530 microns to about 460 microns, and in one embodiment, about 500 microns. It is noted that these particle sizes are averages and that a range of particle sizes will be included.

In one embodiment, the average particle size of the second polymeric material ranges from about 30 mesh to about 50 mesh, and in one embodiment from about 33 to about 37 mesh, and in one embodiment, about 35 mesh. The average particle size of the second polymeric material thus ranges from about 600 microns to about 290 microns, or from about 530 microns to about 460 microns, and in one embodiment, about 500 microns. It is noted that these particle sizes are averages and that a range of particle sizes will be included.

The particle sizes of particles of the comminuted color compound and of the second polymeric material, in one embodiment, may be selected independently of one another, while in another embodiment, the particle sizes of the comminuted color compound and of the second polymeric material are selected to be substantially the same. In another embodiment, the particle sizes of the comminuted color compound and of the second polymeric material are in ranges which substantially overlap. Thus, the first and second polymeric materials may have substantially the same mean particle sizes, while the overall particle size ranges are slightly different, or may have substantially the same overall particle size ranges, while the mean particle sizes are slightly different. By “substantially the same mean particle size”, it is intended that the particle sizes are within about ±10 microns at the particle size ranges indicated above, i.e, in the range from about 600 microns to about 290 microns. By “substantially the same overall particle size range”, it is intended that the range of particle sizes are within about ±50 microns at the particle size ranges indicated above, i.e, in the range from about 600 to about 290 microns. For best results in rotational molding, the particle size ranges of the particles in the mixture of the comminuted color compound and the second polymer should be as narrow as possible and, if possible, the mean particle size of all the particles should be substantially the same. It is noted that while both larger and smaller particle sizes may be possible, it is generally the practice in the rotational molding art to use particle sizes in the foregoing ranges.

Mixing

The step of mixing the reduced particle size color compound with a second polymeric material having a different or contrasting color to form a mixture wherein the reduced particle size color compound is distributed in the second polymeric material may be carried out by any appropriate known mixing apparatus. In one embodiment, the step of mixing may be carried out in a Kelly duplex paddle mixer, operated at a slow rotation, for example about 45-55 RPM. Other suitable mixers may be used.

In one embodiment, the step of mixing is also known and may be referred to as dry-blending these materials. The step of mixing should be carried out for a time sufficient to obtain a uniform mixture of the particles of the reduced particle size color compound with the second polymeric material. In one embodiment, the step of mixing should obtain the uniform mixture but should not significantly change the particle size, and should not result in melting or softening of the respective materials.

Molding

In one embodiment, the step of molding is carried out by rotational molding. Other suitable molding techniques may also be employed. While the present invention is described primarily with reference to rotational molding, the principles of the present invention are broadly applicable to molding processes in general. The invention may be practiced with other molding techniques, such as injection molding, blow molding or extrusion molding. However, it is particularly useful in and suitable for rotational molding. This particular suitability is due to the unique features of the present invention when these are applied in rotational molding, including the externally applied heat for melting the polymeric materials, the lack of any solvent or carrier material, the gradual outside-in melting and the large scale parts made with rotational molding.

In one embodiment, the first polymeric material and the second polymeric material are sufficiently similar that the article displays physical properties corresponding to a single polymeric material. Due to the similarity in the two polymeric materials (and of the color compound made with the first polymeric material), even when the pigment has been compounded with the first polymeric material, the physical properties are substantially the same as a single polymeric material.

One result of this similarity is that during the molding step, prior to sintering or melting of the particles, the particles of the first polymeric material and the second polymeric material remain relatively uniformly mixed, and do not segregate or separate as a result of differences such as the density or weight of the particles. If the particles of the first polymeric material and the second polymeric material differ in density, as a result of the movement of the mold during rotational molding, the particles will separate from each other, and the molded article obtained by the molding process will not have the desired substantially randomly uniform distribution of particles of contrasting color which contributes to the granular or speckled appearance. Instead, the molded article may have a layered appearance in at least some areas, with the layers having one or the other color or some non-uniform combination of the colors. The differences in density cause the particles to be non-uniformly distributed throughout the part.

In one embodiment, the first polymeric material and the second polymeric material are sufficiently similar that in the mixture, particles of the reduced particle size color compound are substantially randomly and uniformly distributed among particles of the second polymeric material, and remain so during the molding step.

In one embodiment, the first polymeric material and the second polymeric material are both rotationally moldable polymeric materials. In one embodiment, the first and second polymers are substantially the same polymeric materials in that both are LLDPE, LDPE, LMDPE, MDPE or HDPE. Thus, in such an embodiment, LLDPE would not be used together with HDPE. In general, for rotational molding, the first polymeric material and the second polymeric material are both the same polymer, for example, both being LLDPE, both being HDPE, etc. In addition, in some embodiments, the properties of the same polymeric material are substantially the same; that is, as defined below, one or more of density, melt flow index and Vicat softening point are substantially similar in the first polymeric material and the second polymer, in addition to the first polymeric material and the second polymeric material being the same polymer, i.e., both being LLDPE or both being HDPE. In general, the more similar the first polymeric material and the second polymeric material are to each other, the better for rotational molding, and the better the physical properties of the resulting article correspond to the physical properties of an article made from a single polymer.

In one embodiment, the first polymeric material and the second polymeric material are substantially similar polymeric materials in one or more of melt flow index, density and Vicat softening point.

In one embodiment, the first polymeric material and the second polymeric material are substantially identical in one or more of melt flow index, density and Vicat softening point. Exemplary Vicat softening points are shown for some commercially available polyethylenes:

| | | | Vicat Softening |
|---|---|---|---|
| Resin Type | Trademark | Vendor | Point, ° F. (˜° C.) |
| HDPE | FORTIFLEX ™ T60-500 | Solvay | 264 (129) |
| LMDPE | DOWLEX ™ 2037 | Dow | 242 (117) |
| (density >0.93) | | | |
| LLDPE | DOWLEX ™ 2045 | Dow | 223 (106) |
| (density <0.93) | | | |
| LDPE | LDPE ™ 4005 | Dow | 190 (88) |

In one embodiment, the polymeric material has a density in a range from about 0.92 to about 0.98, and in one embodiment, from about 0.924 to about 0.945, and in another embodiment from about 0.924 to about 0.942. In one embodiment, the densities of the first and second polymers are substantially the same. In one embodiment, the densities are the same. In one embodiment, the densities are sufficiently similar to provide a substantially randomly uniform distribution of particles of the color compound within the molded article. In one embodiment, the densities are sufficiently similar that during rotational molding there is substantially no layering or density-based separation of the color compound (comprising the first polymer) and the second polymer. If the difference in density is too great, some portion of the more dense material may separate into a distinct layer during the rotational molding operation.

In one embodiment, the difference in density between the first and second polymeric materials is less than about 0.02 g/cc, and in one embodiment, the difference is less than about 0.01 g/cc, and in one embodiment, the difference is less than about 0.005 g/cc, and in one embodiment, the difference is less than about 0.002 g/cc, and in another embodiment, the difference is less than about 0.001 g/cc.

In one embodiment, when the densities of the first and second polymeric materials are “substantially similar”, the densities differ by less than about 0.02 g/cc. In another embodiment, when the densities of the first and second polymeric materials are substantially similar, the densities differ by less than about 0.01 g/cc. In another embodiment, when the densities of the first and second polymeric materials are substantially similar, the densities differ by less than about 0.005 g/cc. In yet another embodiment, when the densities of the first and second polymeric materials are substantially similar, the densities differ by less than about 0.001 g/cc. In still another embodiment, when the densities of the first and second polymeric materials are substantially identical, the densities differ by less than about 0.0005 g/cc.

In one embodiment, the melt flow index of the first and second polymeric materials is in the range from about 1 to about 40 gm/10 min., and in another embodiment, the melt flow index of the first and second polymeric materials is in the range from about 3 to about 20 gm/10 min. The melt flow index of the first and second polymeric materials should be as close together as possible. In one embodiment, the melt flow index is substantially the same.

In one embodiment, the difference in melt flow index between the first and second polymeric materials is less than about 0.5 melt index units (gm/10 min), and in one embodiment, the difference is less than about 0.3 melt index units, and in one embodiment, the difference is less than about 0.1 melt index units. In one embodiment, when the melt flow index of the first and second polymeric materials are substantially the same, the melt flow indices differ by less than the foregoing amounts. In an embodiment in which the melt flow indices are substantially identical, the melt flow indices are either identical or differ by less than about 0.05 melt index units.

If the difference in melt flow between the first and second polymeric materials is too great, a portion of the mixture will melt at a lower temperature and may separate from the higher-melting portion of the mixture, resulting in separation of the polymeric materials and a non-uniform distribution of polymeric materials and, in most cases, of colors. The result may be a product having a striated or otherwise color-separated appearance, and/or a product in which the speckles will not be uniform or uniformly distributed. Such separation may also adversely affect physical properties of the product.

In one embodiment, the Vicat softening point of the first and second polymers ranges from about 100° C. to about 130° C. In another embodiment, the Vicat softening point of the first and second polymers ranges from about 105° C. to about 115° C., and in one, about 106° C.

In one embodiment, the difference between the Vicat softening point, between the first and second polymeric materials is less than about 1° C., and in another embodiment, the difference is less than about 0.5° C. In an embodiment in which the Vicat softening point of the first and second polymeric materials is substantially similar, the difference is less than about 0.2° C., or cannot be determined due to the small difference between the polymeric materials.

In one embodiment, the melting points of the color compound and the second polymeric material are substantially the same.

The properties of the final article can be influenced by the choice of the plastic material used as raw material, the plastic powder physical characteristics and the process parameters, such as heating temperature, heating time, cooling time and other conditions. After selection of the appropriate polymeric materials, especially the physical characteristics of the polymeric material are very important parameters. Good molding polymeric materials for rotational molding should satisfy, among others, the following physical criteria:

The granules should be free flowing, and substantially spherical in shape. The particle size should be relatively small and the particle size distribution of the polymer particles should be relatively narrow. The bulk density of the granules should be high to provide good flowability and close compaction in the mold.

Improved processability refers to reduced viscosity or melt elasticity at zero or low shear rates, which in turn results in shorter cycle times, faster sintering, and/or the ability to fabricate articles over wide ranges of processing temperatures. These characteristics arise from the choice of polymeric materials. Two of the key properties of products made by rotational molding include impact strength at low and room temperature, and tensile strength. Other properties include, for example, flexural modulus and melt flow index (MFI) of the polymeric materials used in the rotational molding. The particle size distribution, density, bulk density and dry flow characteristics of the polymeric materials are also important properties. These properties of the products depend to a great extent upon the composition of the polymeric material from which the products are made, and on the grinding techniques used in reducing the particle size.

In one embodiment, the polymeric material used in the present invention may be a polyolefin that is a homopolymer or copolymer of a C₂-C₁₀ alpha-olefin and in one embodiment, a type used in rotational molding processes. In one embodiment, the polymeric material is a homopolymer or copolymer of ethylene. The latter polymers are usually referred to as polyethylene and the present invention will be particularly described with reference thereto.

In one embodiment, the polyethylene may be a homopolymer of ethylene or a copolymer of ethylene and higher alpha-olefins, for example copolymers of ethylene and at least one C₄-C₁₀ alpha-olefin, examples of which are butene-1,4-methyl pentene-1, hexene-1 and octene-1. Techniques for the manufacture of such polyethylene are known in the art. As will be appreciated by those skilled in the art, polyethylene intended for use in a rotational molding process should have a narrow molecular weight distribution.

In one embodiment, the present invention includes the use of a rotationally moldable polymeric material. A rotationally moldable polymeric material may include a polyolefin such as LLDPE, LDPE, HDPE, polypropylene, polypropylene copolymer, ionomer and nylons.

As known in the art, the density of the polymeric materials is controlled by addition of comonomers to the ethylene polymerization. Suitable comonomers include C₃-C₈ olefins, and in one embodiment, 1-butene, and in another embodiment, 1-hexene, and in another embodiment, 1-octene.

In one embodiment, any type of polymeric material used in conventional rotational molding may be utilized. The particular polymeric material selected will be determined by the requirements for the object or part being rotationally molded. The most common resin used is polyethylene. Many types of polyethylene are commercially available, with a wide range of properties and all may be used. In general, the types of polyethylene available can be described as linear low-density polyethylene, low-density polyethylene, medium-density polyethylene, and high-density polyethylene. Still further, each material type is manufactured using unique technology to achieve desired material physical characteristics and properties. Examples of these are octene, hexene, butene, and metallocene molecular chains used in resin technologies.

Commercially available products for use as the polymeric materials include low density polyethylene (LDPE), linear low density polyethylene (LLDPE), medium density polyethylene (MDPE), linear medium density polyethylene (LMDPE), high density polyethylene (HDPE), polyolefin plastomers, such as those marketed by The Dow Chemical Company under the AFFINITY™ tradename and by Exxon Chemical under the EXACT™ tradename.

In one embodiment, the LLDPE used for rotational molding has a density in the range from about 0.924 to about 0.942 g/cc, a melt flow in the range from about 3 to about 20, and in one embodiment a melt flow from about 3 to about 10, a Vicat softening point in the range from about 85° C. to about 97° C., and in one embodiment from about 90° C. to about 92° C.

In one embodiment, the LLDPE is rotational molding grade LLDPE. Suitable rotational molding grade LLDPE is available from Bamberger as BAPOLENE® LL3039 and LL3042, from Nova as SCLAIR® 8107, from Equistar as MICROTHENE® MPR 12247 and MP, or PETROTHENE® GA, from Exxon/Mobil as ESCORENE® LL-8360, LL-8361, LL-8555, LL-8556, LL-8401, LL-8460, and LL-8461 and from Formosa Plastics as Formolene™ L43840U, L63550U, L63565, L63935, L64220UT1. Another example is an LLDPE (ethylene/hexene copolymer) having a Vicat softening point of 103° C., a density of 0.917 g/cc, a Ml of 4.5 g/l 0 minutes, sold by Exxon under the trademark EXCEED® 361C33.

In one embodiment, the MDPE used for rotational molding has a density in the range from about 0.932 to about 0.947 g/cc, a melt flow in the range from about 3 to about 10, a Vicat softening point in the range from about 105° C. to about 127° C., and in one embodiment from about 108° C. to about 122° C.

In one embodiment, the MDPE is rotational molding grade MDPE. Suitable rotational molding grade MDPE is available from Nova as SCLAIR® 8306, 8405, 8406 or 8504, or as NOVAPOL® TR-0338 or TR-0535.

In one embodiment, the LMDPE used for rotational molding has a density in the range from about 0.932 to about 0.938 g/cc, a melt flow in the range from about 3 to about 10.

In one embodiment, the LMDPE is rotational molding grade LMDPE. Suitable rotational molding grade LMDPE is available from Exxon/Mobil as ESCORENE® LL-8302, LL-8360, LL-8361 or LL-8460, LL-8461, LL-8555, LL-8556 or LX-0252.

In one embodiment, the HDPE used for rotational molding has a density in the range from about 0.940 to about 0.950 g/cc, a melt flow in the range from about 2 to about 20, and in one embodiment, a melt flow from about 3 to about 10.

In one embodiment, the HDPE is rotational molding grade HDPE. Suitable rotational molding grade HDPE is available from Equistar as MICROTHENE® MP, or PETROTHENE® GA, from Exxon/Mobil as ESCORENE® HD-8660, HD-8661, HD-8760 and HD-8761.

In addition, other polyolefins may be used, such as polypropylene homopolymers and polypropylene copolymers. Further, ethylene-vinyl acetate resins may be used. Other types of resins which may be useful in this invention include polycarbonates, nylons, polyvinylchlorides, and polyesters. Additional useful resins include ABS, acetals, acrylics, cellulosics, epoxies, fluorocarbons, phenolics, polystyrenes, polyurethanes, SAN polymers, and silicone polymers. In general, any type of resin which may be rotationally molded may be used with the present invention.

Any useful colorant may be used to provide the desired colors for the particular product being molded. In one embodiment, the carrier polymer is the same as, or similar to, the polymer with which the carrier is to be used, e.g., LLDPE. Any heat stable and unreactive colorants known and available for use for the particular resins may be employed. As illustrative examples, virtually any color can be provided, ranging from white to yellow, red, orange, green, burgundy and black. These colors may be combined to obtain the desired background colors and to obtain the desired color compound colors. As used herein, a colorant comprises one or more pigments dispersed in a polymeric material as a carrier. The one or more pigments may be suitably combined to obtain a desired color in the colorant. Colorants useful with the present invention may be prepared by any suitable method known in the art. The polymeric material used as the carrier should be a resin compatible with the polymeric materials with which the colorant will be used in the molding process.

The colorant generally contains a high loading of pigment. For example, a colorant may contain from about 50 wt % to about 90 wt % of pigment(s), with the remainder being primarily polymer. The colorant is easier to handle than a pigment and is not so easily dispersed into the air or onto surfaces with which it may come into contact as is a pigment. The colorant is used as a coloring agent, much like a pigment, but is more like a partly diluted pigment, since it is mixed with a non-pigment carrier such as a polymeric material. In one embodiment, the colorant comprises one or more pigments dispersed in the same polymeric material as is used in the first and/or second polymeric materials.

In one embodiment, the colorant comprises at least one appropriately selected pigment and a resin which is substantially the same polymeric material as that with which the colorant is to be used. For example, when the polymeric material is rotational molding grade LLDPE, the resin used with the pigment to make the colorant is also rotational molding grade LLDPE. In one embodiment, the polymeric material and the resin used in the colorant have substantially the same melt flow index. By substantially the same melt flow index, the resin used in the colorant has a melt flow index within (±) 0.1 g/l 0 min. of the melt flow index of the polymeric material with which it is used. In another embodiment, the resin used in the colorant has a melt flow index which is within (±) about 0.1 to about 2 g/10 min. of the melt flow index of the polymeric material with which it is used. In another embodiment, the resin used in the colorant has a melt flow index which is within (±) about 0.5 to about 1 g/10 min. of the melt flow index of the polymeric material with which it is used.

Illustrative examples of useful pigments include titanium dioxide, carbon black, iron oxide, ultramarine blue, cadmium sulfide, phthalocyanine green, phthalocyanine blue, chromium oxide, quinacridone red, anthraquinone and perinone dyes. Other inorganic pigments such as cobalt pigments, cadmium pigments and chrome pigments may be suitable. Other organic pigments such as azo pigments, condensed azo pigments, phthalocyanine pigments, quinacridone pigments, isoindolinone pigments, thioindigo pigments, quinophthalone pigments, anthraquinone pigments, dioxazine pigments, perylene pigments and perynone pigments may be used.

In one embodiment, the pigments used are those approved by US Food and Drug Administration (FDA) for use with children's toys and playthings, and in one embodiment the pigments used are those approved by FDA for food contact.

The amount and nature of the colorant used can be varied as is necessary to provide the desired color. In one embodiment, the amount of colorant ranges from about 0.01 wt % to about 10 wt %, based on the weight of polymeric material to which the colorant is added. In another embodiment, the amount of colorant ranges from about 0.1 wt % to about 1 wt %, based on the weight of polymeric material to which the colorant is added. In another embodiment, the amount of colorant ranges from about 0.2 wt % to about 0.5 wt %, based on the weight of polymeric material to which the colorant is added.

In an exemplary embodiment, 2 parts of a powdered colorant and 98 parts of the first polymeric material in powdered form may be mixed dry in a drum mixer. The mixture is fused and homogenized in a screw extruder at a barrel temperature of about 200° C. to 250° C. The extruded material is granulated by face cutting at the die while cooling. The granules thus obtained are then transferred to the comminuting step, together with the other ingredients.

In one embodiment, the granular appearance comprises contrasting color properties between the color compound and the background material. In one embodiment, the granules or speckles may include a plurality of different colors, in which the different colors contrast with each other and/or with the background color. For example, in one embodiment, the background color is beige, and red, white and black color compounds are added.

In one embodiment, the background color may be obtained by adding a pigment or colorant to the second polymeric material (or by adding the pigment or colorant to the mixture of the second polymeric material and the reduced-particle size color compound), or obtained by combining a plurality of second polymeric materials of different colors, or obtained by combining an un-pigmented second polymeric material with one or more additional second polymeric materials to which pigments have been added. Thus, for example, a light brown, sand-like background color may be obtained by a combination of a major portion of un-pigmented second polymeric material with a mixture of red, white and black pigmented color compound and a beige or golden colorant, in which the combination is used in the step of mixing the reduced particle size color compound with the second polymeric material and the background colorant. In one embodiment, mixture of the polymeric materials with the respective colorant and color compound is made subsequent to grinding, when the materials are in a powder or powder-like form.

In one embodiment, the article is substantially free of filler. In one embodiment, the article is free of one or more of additives, emulsifiers, waxes, fillers, dispersion aids, solvents and/or modifiers. One or more of these materials may be added in conventional processes in an effort to obtain the desired granular or speckled appearance. In the present invention, addition of such materials is not necessary to obtain the disclosed granular or speckled appearance.

In one embodiment, the polymeric materials are substantially free of cross-linking. In one embodiment, no cross-linking has been applied to the polymeric materials. In one embodiment, no cross-linking agent is added to the polymeric materials.

The polymeric materials may include stabilizers such as UV stabilizers and storage stabilizers. For example, the polymeric materials may include a UV stabilizer such as a hindered amine such as Tinuvin 328 which is described as a UV absorber identified as 2-(2′-hydroxy-3′, 5′-di-tert-amylphenyl)benzotriazole, and Tinuvin 292 which is a hindered amine light stabilizer identified as bis(1,2,2,6,6-pentamethyl-4-piperidinyl)sebacate, or Cyasorb-5411, which is a UV absorber available from Cytec and is believed to be 2-(2′-hydroxy-5′-octyl phenyl-)benzotriazole. In one embodiment, the UV stabilizer is included in the polymeric material obtained from the manufacturer thereof. The amount of UV stabilizer may be suitably determined by those of ordinary skill in the art based upon the intended use of the article. In one embodiment, the maximum amount of UV stabilizer is 3000 ppm, which is believed to be the maximum allowed by FDA for hindered amines in some applications, such as for food contact.

In one embodiment, the invention further relates to a polymeric material molded article having a speckled appearance with contrasting color properties, including particles of a color compound of a first polymeric material and at least one pigment; and a second polymeric material having a color contrasting with the pigment, in which in the polymeric material molded article the second polymeric material forms a substantially uniform background and the particles of the color compound are substantially randomly and uniformly distributed throughout the second polymeric material and remain substantially distinct from the second polymeric material. The molded article retains the physical properties of the polymeric material from which it is made, and does not sacrifice desirable physical properties in order to achieve the granular or speckled appearance.

Test Methods

1. Impact Strength

Impact Strength is measured by the Gardner Impact Test, using A Gardner Impact Test Apparatus model 1G1130, from BYK Gardner or equivalent. The test is carried out at room temperature (72±10° F. (22±5° C.)) and at −40±5° F. (40±2.77° C.).

A 2 inch by 2 inch (5×5 cm) or larger sample, having a thickness from 0.090 to 0.110 inches (0.229-0.279 cm) is used in this test. Samples taken from the same part are tested at both temperatures. The sample is placed in the testing apparatus, with the outer-facing side of the part upward. The part is allowed to equilibrate at the test temperature for at least one hour prior to testing. The low temperature test must be carried out immediately upon removal of the sample from the freezer.

Using the impact test apparatus, the dart is repeatedly dropped onto the same point on the sample from the following points on the guide tube:
1 drop from 24 in/lb
1 drop from 36 in/lb
1 drop from 48 in/lb
1 or more drops from 60 in/lb until failure occurs.
   The point of failure is recorded.

Failure is determined by cracking or splitting of the impact area. Brittle failure is defined as an uneven break, characterized by a jagged crack through the center or interior of the impact area. Ductile failure is defined as a clean break around a portion of the circumference of the impact area, showing that the material has stretched and pulled apart. Brittle failure generally indicates some problem with the part and is undesirable, while ductile failure is the normal mode and will eventually occur with any part.

Flexural Modulus, at 1% secant, in KPSI (MPa), may be measured using ASTM D-790.

Instrumented Impact Test (IIT) may be measured using a CEAST tester at −40° C. according to ASTM D-3763-86.

Melt Flow Index (or MFI, sometimes referred to simply as “melt flow”) may be measured using ASTM D-1238, Condition E (2160 gm/190° C.), the units in grams/10 minutes (gm/10 min), or decigrams/minute (dg/min).

Particle size and distribution may be measured by the amount retained on screen, as defined by ASTM D-1921 using a Rototap Model B, 100 gm sample, 10 minute shake.

### EXAMPLES

The following examples illustrate mixtures used in preparing the inventive articles having a granular or speckled appearance. The examples are provided to further illustrate some embodiments of the invention, and are not to be considered as limiting thereto. Unless otherwise indicated, in the following examples as well as throughout the specification and in the appended claims, all parts and percentages are by weight, all temperatures are in degrees Celsius and pressures are at or near atmospheric pressure.

### Example 1

An article having a sand-like granular or speckled appearance is prepared having the following overall formulation:

| Parts | Material |
|---|---|
| 0.005 | Background colorant - sandbox beige toner |
| 4.520 | LLDPE virgin powder |
| 0.075 | black color compounded powder |
| 0.150 | red color compounded powder |
| 0.250 | white color compounded powder |
| 5.000 | Total |

The colorant in the foregoing formulation is sand-colored colorant, to provide a sand-colored overall background color. The LLDPE virgin powder is obtained from Exxon/Mobil, and includes a UV absorber. The black pigment is a black polyethylene concentrate; the red pigment is a cherry red micro 1% UV pigment, and the white pigment is a white micro 1.5% UV pigment. The cherry red may include any appropriate pigments. For example, a suitable red color may be obtained containing quinacridone red, and a suitable white color may be obtained containing barium sulfate white and/or titanium dioxide white. As will be understood, there is a very wide variety of pigments which may be used to obtain a given color, and there is an almost limitless range of possible colors. Suitable combinations can be selected by those of ordinary skill in the art. As noted, in some embodiments, the pigments are FDA approved for food contact or toy use. In one embodiment, the pigment is free of heavy metal. In many cases, the exact chemical makeup of any given pigment may be proprietary to the pigment manufacturer.

In Example 1, each of the color compounded powders are prepared in accordance with the present invention, by color compounding LLDPE virgin polymer pellets with a pigment of the indicated color to form a color compound of the pigment with the LLDPE, in which the pigment and pellets are extruded in a single screw extruder. The output of the extruder is cut to form pellets of the color compound. These color compound pellets are then comminuted to reduce the particle size to the desired particle size in the range from about 30 to about 40 US mesh. The LLDPE virgin powder is likewise comminuted to reduce its particle size to the desired particle size. The comminuted color compounds, the comminuted LLDPE virgin powder and the pigment are mixed or dry-blended together to provide a homogenous mixture, in which the comminuted color compounds are distributed in the comminuted LLDPE virgin powder together with the background color pigment. The mixed powders are then placed in a rotary mold to form an article having a sand-like granular or speckled appearance.

A similar article is made using only the background color pigment and the LLDPE virgin powder.

Both articles are tested for physical properties including impact strength and tensile strength. The tests shows that the article made in accordance with the present invention has substantially the same physical properties as the article made with only LLDPE virgin powder and pigment.

### Example 2

An article having a granite-gray granular or speckled appearance is prepared having the following overall formulation:

| Parts | Material |
|---|---|
| 4.975 | LLDPE virgin powder |
| 0.025 | black color compounded powder |
| 5.000 | Total |

In this formulation, no background color pigment is used, the background color being that of the LLDPE virgin powder. The LLDPE virgin powder is obtained from Exxon/Mobil, includes a UV absorber, and is the same as that used in Example 1. The black pigment is the same as that used in Example 1.

In Example 2, the color compounded powder is prepared in accordance with the present invention, by color compounding LLDPE virgin polymer pellets with a black pigment to form a color compound of the pigment with the LLDPE, in which the pigment and pellets are extruded in a single screw extruder. The output of the extruder is cut to form pellets of the black color compound. The black color compound pellets are then comminuted to reduce the particle size to the desired particle size in the range from about 30 to about 40 US mesh. The LLDPE virgin powder is likewise comminuted to reduce its particle size to the desired particle size. The comminuted color compound and the comminuted LLDPE virgin powder are mixed or dry-blended together to provide a homogenous mixture, in which the comminuted color compound is distributed in the comminuted LLDPE virgin powder. The mixed powders are then placed in a rotary mold to form an article having a granite-gray granular or speckled appearance.

A similar article is made using only the LLDPE virgin powder.

Both articles are tested for physical properties including impact strength and tensile strength. The tests shows that the article made in accordance with the present invention has substantially the same physical properties as the article made with only LLDPE virgin powder.

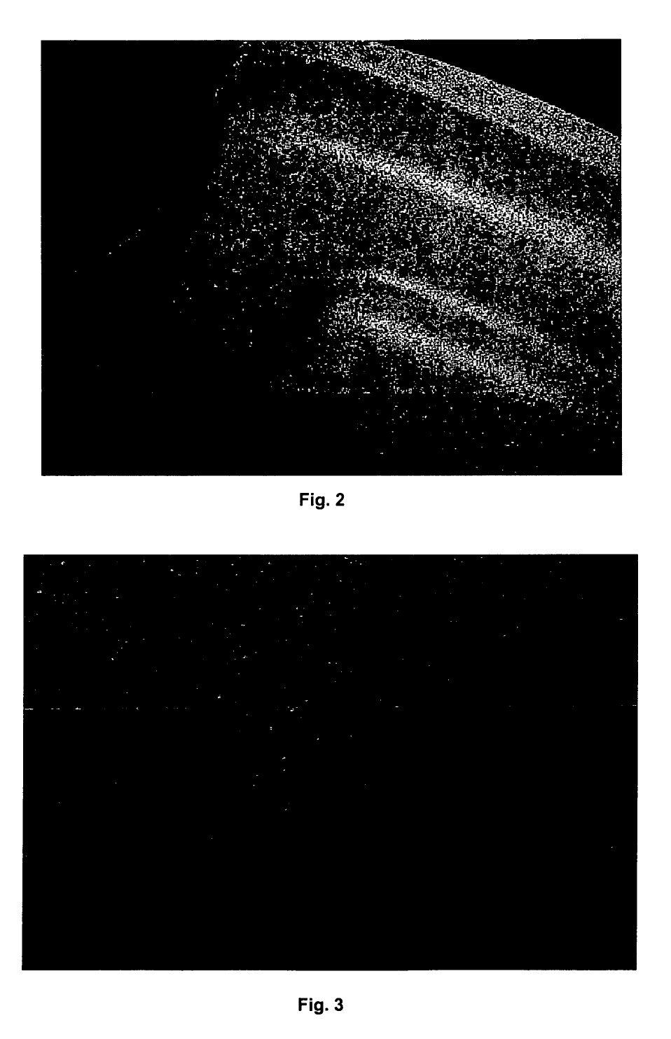

FIGS. 2 and 3 are photographs of articles made in accordance with the process of the present invention. FIG. 2 is a photograph of a molded article made in accordance with an embodiment of the invention in which the molded article has a granular or speckled appearance like that of sand. The molded article shown in FIG. 2 is made using a formulation such as that of Example 1. FIG. 3 is a photograph of a molded article made in accordance with an embodiment of the invention in which the molded article has a granular or speckled appearance like that of granite. The articles shown in FIG. 3 is made using a formulation such as that of Example 2. As shown in FIGS. 2 and 3, in both cases, the granular appearance includes contrasting color properties between the background color and the color of the particles forming the granular or speckled appearance. As shown in FIGS. 2 and 3, both molded articles include a substantially randomly uniform distribution of particles of the color compound within the molded article. As shown in FIGS. 2 and 3, in both molded articles, the second polymeric material forms a substantially uniform background and the particles of the color compound are substantially randomly and uniformly distributed throughout the second polymeric material and are substantially distinct from the second polymeric material.

### Comparative Example

In this example, an article having a granite-gray granular or speckled appearance is attempted to be prepared by using reground polymeric material in place of the comminuted color compound material. A blue polymeric material is first prepared having the following overall formulation:

| Parts | Material |
|---|---|
| 0.997 | LLDPE virgin powder |
| 0.003 | blue colorant powder (i.e., 0.3 wt %) |
| 1.000 | Total |

This mixture is thoroughly mixed in a conventional manner for making a uniformly blue-colored part, and is fed into a rotational molding apparatus to form a uniformly blue-colored part. The blue-colored part is then reground and comminuted into particles having an average particle size in the range from about 32 to about 38 mesh. The comminuted reground blue polymeric material is then added to similarly ground virgin polymeric material (LLDPE) at a 5 wt % loading and mixed thoroughly as described above. The mixture is then fed to a rotational molding device in an attempt to form a granular or speckled part. The part obtained from this process has an overall blue color with blue partially dispersed particles scattered throughout the part. The blue particles do not have sharp edges or boundaries, but instead have a “halo” or “aura” appearance, in which a portion of the outer surface of each particle is melted into the surrounding polymeric matrix. Thus, the part can be described as having an overall blue color in which some areas are darker than others. In short, the part does not have the granular or speckled appearance which can be obtained by the process of the present invention. In comparison with the parts formed in Examples 1 and 2, the part has very poor granularity and the speckles or particles are not cleanly separate from the surrounding bulk medium.

Although the invention has been shown and described with respect to certain preferred embodiments, equivalent alterations and modifications will occur to others skilled in the art upon reading and understanding this specification and the annexed drawings. In particular regard to the various functions performed by the above described integers (components, assemblies, devices, compositions, steps, etc.), the terms (including a reference to a :means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiment or embodiments of the invention. In addition, while a particular feature of the invention may have been described above with respect to only one of several illustrated embodiments, such feature may be combined with one or more other features of the other embodiments, as maybe desired and advantageous for any given or particular application.

1. A process for making a molded article having a granular or speckled appearance, comprising:
color compounding a first polymeric material and at least one pigment to form a color compound of the at least one pigment with the first polymeric material;
comminuting the color compound to form a reduced particle size color compound;
mixing the reduced particle size color compound with a second polymeric material having a color different from or contrasting with the at least one pigment to form a mixture wherein the reduced particle size color compound is distributed in the second polymeric material; and
molding the mixture to form a molded article having a granular appearance.

2. The process of claim 1, wherein the color compound has a substantially uniform distribution of the at least one pigment within the first polymeric material.

3. The process of claim 1, wherein the color compounding comprises extrusion of the first polymeric material and the at least one pigment.

4. The process of claim 1, wherein reducing the particle size comprises one or more of cutting, chopping, grinding and milling the color compound.

5. The process of claim 1, wherein the first polymeric material and the second polymeric material are substantially similar polymeric materials in one or more of melt flow index, density, and Vicat softening point.

6. The process of claim 1, wherein the first polymeric material and the second polymeric material are substantially identical in one or more of melt flow index, density, and Vicat softening point.

7. The process of claim 1, wherein the molding is rotational molding.

8. The process of claim 1, wherein the granular appearance includes a controllable granule size.

9. The process of claim 8, wherein the controllable granule size is controlled in the step of reducing particle size.

10. The process of claim 1, wherein the molded article is free of one or more of additives, fillers, dispersion aids, solvents and/or modifiers.

11. The process of claim 1, wherein the granular appearance comprises contrasting color properties.

12. The process of claim 1, wherein the melting temperatures of the color compound and the second polymeric material are substantially the same.

13. The process of claim 1, wherein the molded article is substantially free of filler.

14. The process of claim 1, wherein the first polymeric material and the second polymeric material comprise one or more of LLDPE, LDPE, MDPE, LMDPE, or HDPE.

15. The process of claim 1, wherein the first polymeric material and second polymeric material each have a density in a range from about 0.924 to about 0.942.

16. The process of claim 15, wherein the densities of the first polymeric material and second polymeric material are substantially the same.

17. The process of claim 15, wherein the densities of the first polymeric material and second polymeric material are sufficiently similar to provide a substantially randomly uniform distribution of particles of the color compound within the molded article.

18. The process of claim 1, wherein the first polymeric material and the second polymeric material are sufficiently similar that the molded article displays at least one physical property corresponding to a single polymeric material.

19. The process of claim 1, wherein the first polymeric material and the second polymeric material are sufficiently similar that the color compound is substantially randomly and uniformly distributed in the second polymeric material in the molding step.

20. The process of claim 1, wherein the pigment is provided in the form of a colorant comprising a polymer and the at least one pigment.

21. The process of claim 1, wherein the step of color compounding is carried out on reground polymeric material, in which the first polymeric material and the at least one pigment are provided in the form of reground polymeric material.

22. A molded article having a granular or speckled appearance with contrasting color properties, comprising
particles of a color compound of a first polymeric material and at least one pigment; and
a second polymeric material having a color different from or contrasting with the pigment,
wherein in the molded article the second polymeric material forms a substantially uniform background and the particles of the color compound are substantially randomly and uniformly distributed throughout the second polymeric material and are substantially distinct from the second polymeric material.

23. The article of claim 22, wherein the first polymeric material and the second polymeric material are substantially similar polymeric materials in one or more of melt flow index, density, and Vicat softening point.

24. The article of claim 22, wherein the first polymeric material and the second polymeric material are substantially identical in one or more of melt flow index, density, and Vicat softening point.

25. The article of claim 22, wherein the article is free of one or more of additives, fillers, dispersion aids, solvents and/or modifiers.

26. The article of claim 22, wherein the density of the color compound and the second polymeric material are substantially the same.

27. The article of claim 22, wherein the first polymeric material and the second polymeric material comprise one or more of LLDPE, LDPE, MDPE, LMDPE, or HDPE.

28. The article of claim 22, wherein the first polymeric material and second polymeric material each have a density in a range from about 0.924 to about 0.942.

29. The article of claim 28, wherein the densities of the first polymeric material and second polymeric material are substantially the same.

30. The article of claim 28, wherein the densities of the first polymeric material and second polymeric material are sufficiently similar to provide a substantially randomly uniform distribution of particles of the color compound within the article.

31. The article of claim 22, wherein the first polymeric material and the second polymeric material are sufficiently similar that the article displays at least one physical property corresponding to a single polymeric material.

32. The article of claim 22, wherein the pigment is provided in the form of a colorant comprising a polymer and the at least one pigment.

33. The article of claim 22, wherein the first polymeric material and the at least one pigment are provided in the form of reground polymeric material.
